(19) United States
(12) Patent Application Publication
(10) Pub. No.: US 2013/0079208 A1
(43) Pub. Date: Mar. 28, 2013

(54) METHOD FOR FOLDING AIRBAG CUSHION

(71) Applicants: Richard WIIK, Fort Gratiot, MI (US); Scott D. THOMAS, Novi, MI (US)

(72) Inventors: Richard WIIK, Fort Gratiot, MI (US); Scott D. THOMAS, Novi, MI (US)

(73) Assignees: GM GLOBAL TECHNOLOGY OPERATIONS LLC, Detroit, MI (US); TK HOLDINGS INC., Auburn Hills, MI (US)

(21) Appl. No.: 13/531,651

(22) Filed: Jun. 25, 2012

Related U.S. Application Data
(60) Provisional application No. 61/539,428, filed on Sep. 26, 2011.

(51) Int. Cl. B31B 1/26

(52) U.S. Cl. 493/405

(57) ABSTRACT

A method is provided for folding an airbag cushion assembly having first and second opposed panels attached to a mounting bracket and sewn together at the panel peripheral edges, and upper and lower tethers attached to the mounting bracket and to the panel peripheral edges, said upper and lower tethers being shorter in length than the distance from the mounting bracket to the panel peripheral edges. The method includes laying the cushion assembly on a table with upper and lower tethers on the bottom and the panel peripheral edges folded underneath due to the tethers being shorter. A fold is made in the first and second panels but not the tethers, to shorten the first and second opposed panels and unfold the peripheral edges that had been folded underneath. Then the cushion is rolled and then folded to obtain a folded airbag cushion lying atop the mounting bracket.

### FIELD OF THE INVENTION

The present invention relates to an improved method for folding a side impact airbag cushion into a compact package that will conveniently mount on a seat back, and, upon inflation, inflate in a manner that optimizes occupant restraint.

### BACKGROUND OF THE INVENTION

It is known that the performance of a occupant restraining airbag cushion can depend upon the manner in which the airbag is folded into a housing. Upon inflation, the airbag emerges from the housing and proceeds to unfold and expand into its occupant restraining position.

Our co-pending patent application U.S. Ser. No. 13/244,354 filed Sep. 24, 2011, and entitled SIDE IMPACT AIRBAG CUSION provides a new and improved side impact airbag cushion.

The present invention relates to an improved method for folding the airbag into a compact package that can be conveniently mounted on a seat back, and, upon inflation, the airbag will inflate in a manner that optimizes occupant restraint.

### SUMMARY OF THE INVENTION

A method is provided for folding an airbag cushion assembly having first and second opposed panels attached to a mounting bracket and sewn together at the panel peripheral edges, and upper and lower tethers attached to the mounting bracket and to the panel peripheral edges, said upper and lower tethers being shorter in length than the distance from the mounting bracket to the panel peripheral edges. The method includes laying the cushion assembly on a table with upper and lower tethers on the bottom and the panel peripheral edges folded underneath due to the tethers being shorter. A fold is made in the first and second panels but not the tethers, to shorten the first and second opposed panels and unfold the peripheral edges that had been folded underneath. Then the cushion is rolled and then folded to obtain a folded airbag cushion lying atop the mounting bracket.

Further areas of applicability of the present invention will become apparent from the detailed description provided hereinafter. It should be understood that the detailed description and specific examples, while indicating exemplary embodiments of the invention, are intended for purposes of illustration only and do not limit the scope of the invention.

### BRIEF DESCRIPTION OF THE DRAWINGS

The present invention will become more fully understood from the detailed description and the accompanying drawings, wherein:

FIG. 1 is a perspective view of an airbag cushion inflated between a driver and a console.

FIG. 2 is another perspective view of the airbag cushion of FIG. 1.

FIG. 3 is a side elevation view of the inflated airbag cushion of FIG. 1.

FIG. 4 shows the airbag cushion of FIGS. 1-3 laid flat upon a table with parts of the cushion turned underneath because an upper tether and a lower tether are shorter in length than the size of the airbag panels.

FIG. 5 shows a first step in folding the airbag of FIG. 4.

FIGS. 6-11 show the progression of additional steps that accomplish a completed folding up of the airbag cushion.

### DETAILED DESCRIPTION OF THE EXEMPLARY EMBODIMENTS

The following description of certain exemplary embodiments is merely exemplary in nature and is not intended to limit the invention, its application, or uses.

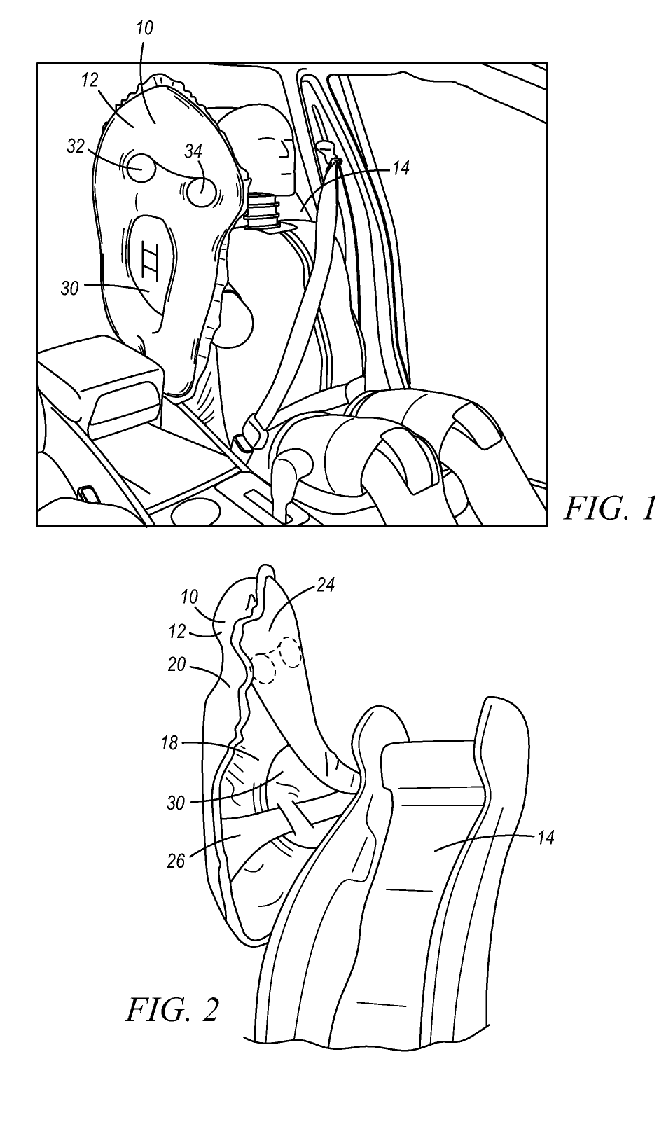

Referring to FIGS. 1 and 2, a side impact airbag 10 is shown, having a cushion 12 shown in its inflated condition for restraint of a seated occupant. In FIGS. 1 and 2, the cushion 12 has inflated and emerged from a housing, not shown, mounted on the inboard side of the seat back 14. The cushion 12 of FIGS. 1 and 2 is described in detail in our co-pending patent application U.S. Ser. No. 13/244,354, filed Sep. 24, 2011, and entitled SIDE IMPACT AIRBAG CUSION.

In general, the cushion 12 is constructed of sewn together first and second opposed panels of flexible sheet material including an occupant facing panel 18, and opposite-facing panel 20 facing away from the occupant, an upper tether 24, and a lower tether 26. The occupant facing panel 18 and the opposite-facing panel 20 are sewn together around their outside peripheral edges and also have additional attachments there between which will cooperate to define unfilled regions 30, 32 and 33 of the cushion. The upper tether 24 and the lower tether 26 are somewhat shorter in length than the extended length of the occupant facing panel 18 and opposite-facing panel 20 so that the tethers 24 and 26 will cooperate to rotate the inflating cushion 12 inwardly toward the seated occupant. Reference may be had to the co-pending patent application for a more comprehensive discussion of the construction and function of the airbag assembly of FIGS. 1 and 2.

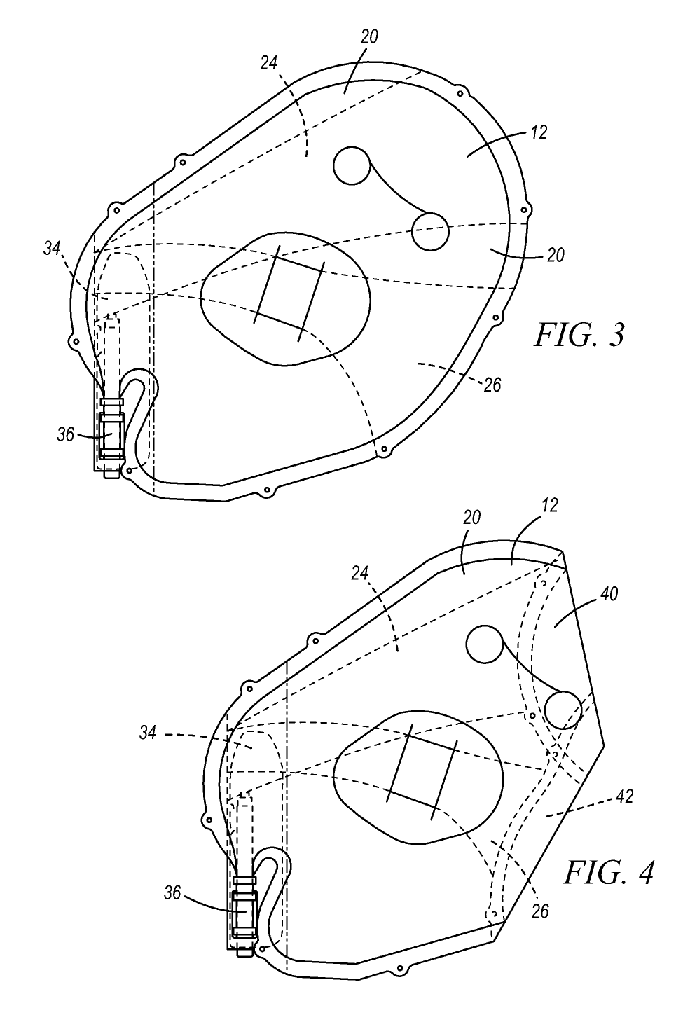

FIG. 3 is a view similar to FIG. 1 but showing the inflated airbag in a straight on side view, without showing the seat back 14. The airbag cushion 12 is attached to a mounting bracket 34 that will mount the cushion 12 on the seat back 14. As seen in the drawings, the mounting bracket 34 is generally rectangular in shape and will serve as the rigid backbone for the cushion 12 that will be rolled and folded as described herein to lie generally atop the mounting bracket. An inflator 36 is also attached to the mounting bracket 34. The cushion 12 must be folded in such a way as to become packaged atop the mounting bracket 34. Then the mounting bracket 34 will be installed on the seat back to be concealed within the seat back cushion.

FIG. 4 shows the cushion 12 of FIG. 3 laid flat upon a table. Because the tethers 24 and 26 are shorter in length than the extended length of the occupant facing panel 18 and the opposite-facing panel 20, a segment 40 of the cushion 12 to which the upper tether 24 is attached must be folded underneath in order for the tether 24 and the remainder of the cushion 12 to lie flat on the table. Likewise a segment 42 of the cushion 12 to which the lower tether 26 is attached must also be folded underneath in order for the lower tether 26 and the remainder of the cushion 12 to lie flat upon table.

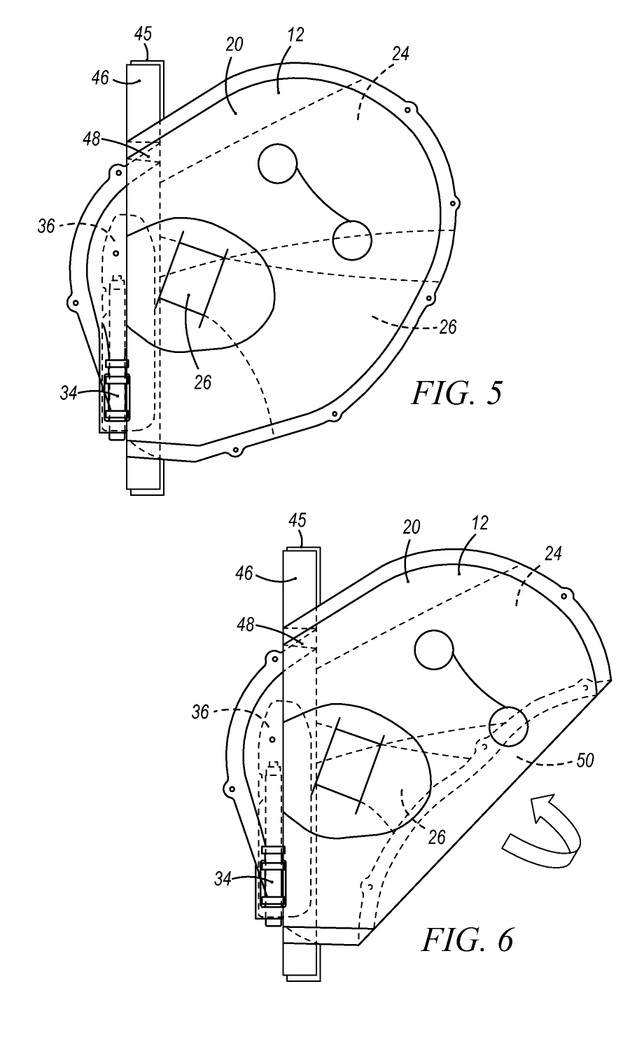

FIG. 5 shows the first step in folding up the cushion 16 atop the mounting bracket 34 so that the cushion 16 can be mounted on the seat back 14. In FIG. 5, a pair of paddles 45 and 46 have been employed to make a fold in the cushion 12. Paddle 46 has been inserted through the cushion 12, beneath the occupant facing panel 18, but above the upper tether 24 and lower tether 26. The second paddle 45 has been laid atop the opposite-facing panel 20. Then the paddles 45 and 46 were squeezed together and rotated 180° , thereby twisting the occupant facing panel 18 and the opposite facing panel 20. This twisting has formed a Z-shaped fold 48 which, in effect, creates a tuck which shortens and stores some of the length of the occupant facing panel 18 and the opposite-facing panel 20, while the upper tether 24 and lower tether 26 remain unaffected and lying flat upon the table. Thus, the folded-underneath segments 40 and 42 that were seen in FIG. 4 have now been unfolded due to the twisting of the occupant facing panel 18 and opposite-facing panel 20 about the paddles 45 and 46, while the tethers 24 and 26 lie undisturbed on the table. The width of the paddles 45 and 46 can be chosen to adjust the size of the z-shaped fold. And, if desired, the number of revolutions of the paddles can be varied, to make multiple Z-shaped folds to accomplish the transition from FIG. 4 to FIG. 5. It will be understood that the Z-shaped fold can be formed via other procedures, with or without one or more paddles or other folding tools.

In FIG. 6, the next step for folding the airbag includes folding under a lower corner segment 50 of the cushion 12 to which the lower tether 26 is attached. This folding under of lower corner segment 50 will also fold under the lowermost end of the tether 26.

In FIG. 7, the top half segment 52 of the cushion 12 that extends above the mounting bracket 34 is ftheolded down to lie atop the remainder of the cushion 12. The paddles 45 and 46 are slid lengthwise and removed from the Z-shaped fold 48 that had been performed in FIG. 5.

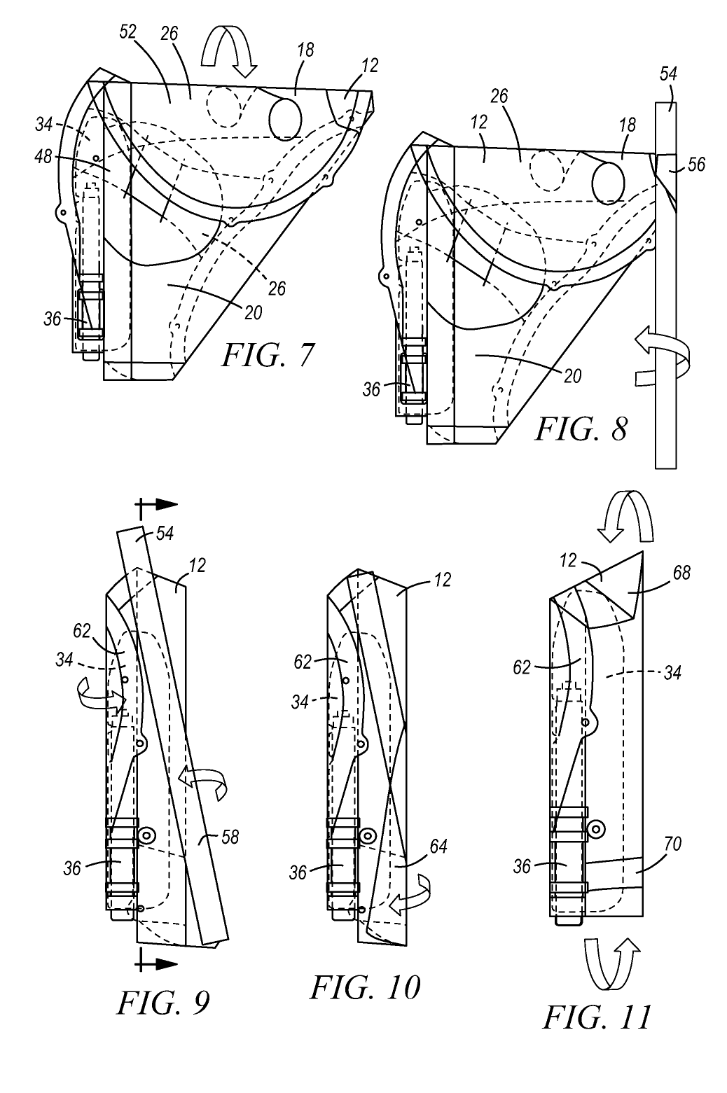

In FIG. 8, a paddle 54 is used to progressively rollup the forward most end 56 of the cushion 12 to achieve the rollup 58 shown in FIG. 9. The paddle 54 is relatively thin and flat so that the rollup 58 is a flat rollup.

In FIG. 9, the rollup 58 has been completed. Also in FIG. 9, segment 62 of the cushion 12 that lies rearward of the mounting bracket 34 is folded forwardly to lie atop the cushion 12 and mounting bracket 34.

In FIG. 10, the lower corner 64 of the rollup 58 is folded atop the cushion 12.

In FIG. 11, the top portion 68 of the cushion 12 is folded downwardly, and the bottom portion 70 is folded upwardly to thereby shorten the overall height of the folded cushion 12 to lie atop the mounting bracket 34.

Having achieved the fully folded up position of FIG. 11, the cushion 12, with the mounting bracket 34 and inflator 36 is ready for the next step where a cover is placed over the assembly prior to mounting on seat back. The foregoing method of folding the airbag has thus achieved a package size that is proper for mounting on a seat back, and also a folded condition that will properly unfold to the inflated condition of FIGS. 1 and 2 for restraint of the seated occupant along a trajectory that avoids catching on the occupant or seat structure during unfolding.

What is claimed is:

1. A method for folding an airbag cushion assembly having first and second opposed panels attached to a mounting bracket and sewn together at the panel peripheral edges, and an upper tether and a lower tether attached to the mounting bracket and to the panel peripheral edges, said upper and lower tethers being shorter in length than the distance from the mounting bracket to the panel peripheral edges, comprising:
laying the cushion assembly on a table with upper and lower tethers on the bottom and the panel peripheral edges folded underneath due to the tethers being shorter;
making a fold in the first and second panels but not the tethers, to shorten the first and second opposed panels and thereby unfold the peripheral edges that had been folded underneath;
and thereafter proceeding to fold and roll the first and second opposed panels and the upper and lower tethers to obtain a folded airbag cushion assembly.

2. The method of claim 1 further comprising the making a fold in the first and second opposed panels being performed by inserting paddles on opposite sides of the first and second opposed panels and rotating the paddle 180° to rotate the first and second opposed panels there with thereby forming a Z-shaped fold in the first and second opposed panels but not the upper and lower tethers.

3. The method of claim 1 further comprising the folding and rolling the first and second opposed panels and the upper and lower tethers including folding underneath a lower corner segment of the first and second opposed panels to which the lower tether is attached.

4. The method of claim 1 further comprising the folding and rolling of the first and second opposed panels and the upper and lower tethers including folding downwardly a top half segment of the first second opposed panels that extends above the height of the mounting bracket to lie atop the remainder of the cushion.

5. The method of claim 4 further comprising after folding downwardly the top half segment, rolling up the cushion beginning at a forward most end furthest from the mounting bracket to create a rollup generally lying atop the mounting bracket.

6. The method of claim 5 further comprising after rolling up the cushion proceeding to fold in and fold up and fold down any remaining portions of the cushion not already lying atop the mounting bracket so that the cushion generally lies atop the mounting bracket .

7. The method of claim 5 further comprising the rolling up of the cushion being performed by laying a paddle on the cushion at the forward most end furthest from the mounting bracket and successively rotating the paddle to rollup the cushion and obtain a flat rollup of the cushion about the paddle.

8. The method of claim 5 further comprising after rolling up the cushion proceeding to fold atop the cushion the lower corner thereof to lie generally atop the mounting bracket.

9. The method of claim 8 further comprising after the folding of the lower corner then folding upwardly the remaining portion of the cushion not already lying atop the mounting bracket.

10. The method of claim 5 further comprising after the rolling up of the cushion folding downwardly the remaining portion of the cushion not already lying atop the mounting bracket.

11. A method for folding an airbag cushion assembly having first and second opposed panels attached to a mounting bracket and sewn together at the panel peripheral edges, and an upper tether and a lower tether attached to the mounting bracket and to the panel peripheral edges, said upper and lower tethers being shorter in length than the distance from the mounting bracket to the panel peripheral edges, comprising:
laying the cushion assembly on a table with upper and lower tethers on the bottom and the panel peripheral edges folded underneath due to the tethers being shorter;
making a fold in the first and second panels but not the tethers, to shorten the first and second opposed panels and thereby unfold the peripheral edges that had been folded underneath;
and thereafter proceeding to fold and roll the first and second opposed panels and the upper and lower tethers to obtain a folded airbag cushion assembly including the steps of;
folding underneath a lower corner segment of the first and second opposed panels to which the lower tether is attached,
folding downwardly a top half segment of the first second opposed airbags that extends above the height of the mounting bracket to lie atop the remainder of the cushion,
rolling up the cushion beginning at the forward most end to create a rollup generally lying atop the mounting bracket,
and after rolling up the cushion proceeding to fold the remaining portions of the cushion not already lying atop the mounting bracket so that the entire cushion generally lies atop the mounting bracket .

12. The method of claim 11 further comprising the rolling up of the cushion being performed by laying a paddle on the cushion at the forward end and successively rotating the paddle to rollup the cushion and obtain a flat rollup of the cushion about the paddle.

13. The method of claim 11 further comprising the folding of the remaining portions including folding a lower corner of the cushion to lie generally atop the mounting bracket.

14. The method of claim 13 further comprising after the folding of the lower corner then folding upwardly a lower remaining portion of the cushion not already lying atop the mounting bracket.

15. The method of claim 11 further comprising after the rolling up of the cushion folding downwardly an upper remaining portion of the cushion not already lying atop the mounting bracket.

16. The method of claim 11 further comprising the making a fold in the first and second opposed panels being performed by inserting one paddle between the first and second opposed panels and the first and second tethers and laying a second paddle on top of the first and second opposed panels and rotating the paddles 180° to rotate the first and second opposed panels therewith thereby forming a Z-shaped fold in the first and second opposed panels but not in the first and second tethers.

17. The method of claim 11 further comprising the rolling up of the cushion being performed by laying a paddle on the cushion at the forward end and successively rotating the paddle to rollup the cushion and obtain a flat rollup of the cushion about the paddle.

18. A method for folding an airbag cushion assembly having first and second opposed panels attached to a mounting bracket and sewn together at the panel peripheral edges, and an upper tether and a lower tether attached to the mounting bracket and to the panel peripheral edges, said upper and lower tethers being shorter in length than the distance from the mounting bracket to the panel peripheral edges, comprising:
laying the cushion assembly on a table with upper and lower tethers on the bottom and the panel peripheral edges folded underneath due to the tethers being shorter;
making a fold in the first and second panels but not the tethers, to shorten the first and second opposed panels and thereby unfold the peripheral edges that had been folded underneath;
and thereafter proceeding to fold and roll the first and second opposed panels and the upper and lower tethers to obtain a folded airbag cushion assembly including the steps of;
folding underneath a lower corner segment of the first and second opposed panels to which the lower tether is attached,
folding downwardly a top half segment of the first second opposed airbags that extends above the height of the mounting bracket to lie atop the remainder of the cushion,
rolling up the cushion beginning at the forward most and to create a rollup generally lying atop the mounting bracket,
and after rolling up the cushion,
folding a lower corner of the cushion to lie generally atop the mounting bracket and after the folding of the lower corner then folding upwardly a lower remaining portion of the cushion not already lying atop the mounting bracket,
and folding downwardly an upper remaining portion of the cushion not already lying atop the mounting bracket.

19. The method of claim 18 further comprising the making a fold in the first and second opposed panels being performed by inserting a paddle between the first and second opposed panels and the first and second tethers and rotating the panel 180° to rotate the first and second opposed panels therewith thereby forming a Z-shaped fold in the first and second opposed panels but not in the first and second tethers.

20. The method of claim 18 further comprising the rolling up of the cushion being performed by laying a paddle on the cushion at the forward end and successively rotating the paddle to rollup the cushion and obtain a flat rollup of the cushion about the paddle.
